(19) United States
(12) Patent Application Publication
(10) Pub. No.: US 2002/0135728 A1
(43) Pub. Date: Sep. 26, 2002

(54) Display substrate

(75) Inventors: Sumitaka Tatsuta, Shizuoka (JP); Toshiaki Aono, Shizuoka (JP); Kohei Arakawa, Tokyo (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/095,056

(22) Filed: Mar. 12, 2002

(30) Foreign Application Priority Data
Mar. 12, 2001 (JP) 2001-68726
Mar. 12, 2001 (JP) 2001-68727
Mar. 12, 2001 (JP) 2001-68728

(51) Int. Cl. G02F 1/1333

(52) U.S. Cl. 349/158

(57) ABSTRACT

A display substrate comprising a plastic film whose average light transmittance in wavelengths of 400 to 700 nm is 70% or more and whose glass transition point is 100° C. or more, and a gas barrier layer that contains an inorganic layered compound and polymers is provided.

### BACKGROUND OF THE INVENTION

1. Field of the Invention

The present invention relates to a display substrate suitable for display devices of various forms, such as personal computers, AV machines, cellular phones, data communications equipment, game/simulation machines, and vehicle navigation systems. Particularly, the present invention relates to a display substrate suitable for use in two-terminal element type liquid crystal displays, three-terminal element type liquid crystal displays, STN (super twisted nematic) liquid crystal displays, and the like.

2. Description of the Related Art

Conventionally, a STN liquid crystal display, a MIN liquid crystal display, a TFT liquid crystal display, etc., have been used as information equipment or telecommunications equipment. A borosilicate glass plate, a soda lime glass plate, a non-alkali glass plate, etc., each of which is less than 1 mm in thickness, are used as substrates for these liquid crystal displays. However, a problem resides in that the glass plate has low shock resistance and is broken when it falls. For this reason, various techniques in which plastic substrates are used instead of such glass plates have been provided.

However, the plastic substrate is lower in gas barrier properties against, for example, oxygen than the glass substrate. Therefore, since high gas barrier properties are required to preferably maintain the performance of liquid crystals when the plastic substrate is used as a substrate of a liquid crystal display, various techniques for characterizing high gas barrier properties of the plastic substrate have been studied.

For example, Japanese Patent No. 3054235 discloses a technique for making a gas barrier layer out of resins, such as polyvinyl chloride, polyester, polyacrylonitrile, vinyl alcohol, and copolymers thereof, and a technique for making a vapor deposition layer out of inorganic compounds, such as silicon dioxide. Additionally, Japanese Patent No. 3059866 discloses a technique for fixing an ultra thin glass plate whose thickness is 0.0015 to 0.25 mm onto a plastic.

However, a problem has arose in that a layer that has desirable gas barrier properties must be thickened if the layer is made out of an organic substance such as polyvinyl alcohol. Another problem has resided in that the gas barrier properties are greatly affected by humidity. Still another problem has resided in that, although the gas barrier layer may be thinned if the layer is made out of inorganic compounds, the layer cracks when stress is imposed thereon or it accompanies high costs. Still another problem has resided in that, when ultra thin glass plates are used, they are easily broken, and there is a technical difficulty in fixing them onto plastics with high yields, thus leading to high costs.

### SUMMARY OF THE INVENTION

It is therefore an object of the present invention to provide a display substrate that is capable of overcoming the conventional problems mentioned above, that is easily reduced in weight and in thickness, that is capable of withstanding large shocks, that is superior in flatness and in adhesive properties to ITO electrodes, that is easily manufactured, that is superior in gas barrier properties, and that is capable of exhibiting high performance in a wide band.

The display substrate of the present invention includes a plastic film, whose average light transmittance at wavelengths of 400 to 700 nm is 70% or more and whose glass transition point is 100° C. or more, and a gas barrier layer that contains an inorganic layered compound and polymers.

The display substrate of the present invention includes a plastic film and a gas barrier layer. The gas barrier layer contains an inorganic layered compound and polymers. The inorganic layered compound is cleft into a great many laminas. The laminas are dispersed in directions almost perpendicular to the thickness direction of the gas barrier layer while being layered with gaps thereamong. The inorganic layered compound itself is superior in gas barrier properties. Therefore, gas must pass through the gas barrier layer as follows. The gas first enters the gas barrier layer from one surface of the gas barrier layer, thereafter the gas travels through the gas barrier layer along the layer walls of the laminas, which have been layeredly dispersed, of the inorganic layered compound, thereafter the gas repeatedly travels through the gas barrier layer in the thickness direction thereof at the end of the layer wall, and the gas reaches the other surfaces of the gas barrier layer, thus passing through the gas barrier layer. Therefore, in order for the gas to pass through the gas barrier layer, the gas must cover a much longer distance in the gas barrier layer than the distance in the thickness direction of the gas barrier layer. As a result, the gas seldom passes through the gas barrier layer, and the display substrate of the present invention has excellent gas barrier properties.

Additionally, in the gas barrier layer, the inorganic layered compound is preferably dispersed between the polymers, and a general applying method may be employed to form it. Therefore, the gas barrier layer has no problem with strength, such as cracking, and may be easily formed with high productivity, and may be manufactured at low costs. Accordingly, as a result of the fact that the inorganic layered compound is contained in the gas barrier layer, the present invention can provide a display substrate that is easily reduced in weight and in thickness, that is capable of withstanding large shocks without being cracked, that is superior in planarity and in adhesive properties to ITO electrodes, that is easily manufactured, that is superior in gas barrier properties, and that is capable of exhibiting high performance in a wide band, as mentioned above.

### BRIEF DESCRIPTION OF THE DRAWINGS

FIG. 1 is a schematic structural view of a co extruder preferably used to form a laminated body when the display substrate of the present invention has a laminated body.

FIG. 2 is a graph showing a measurement result of the wavelength dispersion of retardation (Re) with respect to the display substrate obtained according to Embodiment 1 of the present invention by use of a retardation measurer.

### DETAILED DESCRIPTION OF THE PREFERRED EMBODIMENTS

A display substrate of the present invention includes a plastic film, a gas barrier layer, and, if necessary, other members.

[Gas Barrier Layer]

The gas barrier layer contains an inorganic layered compound, polymers, and, if necessary, other components.

—Inorganic Layered Compound—

The inorganic layered compound has a laminated structure that includes unit crystal lattice layers with thicknesses of 10 to 15 angstroms, and the substitution ratio of metal atoms in the lattice of each crystal lattice layer is conspicuously larger than that of other clay minerals. Therefore, the crystal lattice layers have a shortage of positive charges, and, in order to compensate for this, cations are adsorbed and placed between the layers. The cations (exchangeable cations) that are placed between the layers may be exchanged with various cations. Especially, if the ionic radius of the cation is small, the inorganic layered compound is greatly swelled by, for example, water, because bonding strength between the layered crystal lattice layers is low. If the inorganic layered compound is shared while being swelled, it is easily cleaved, and a stable sol is formed in water.

The inorganic layered compound is expressed as, for example, the general formula A(B,C)₂₋₃Si₄O₁₀(OH,F,O)₂, where A is either Na or Li, B is either Mg or Li, and C is either Mg or Li. In this inorganic layered compound, Li⁺, Na⁺, Ca²⁺, Mg²⁺, etc., are mentioned as the cations (exchangeable cations) that are placed between the layers. If the cations are limited especially to Li⁺ and Na⁺ thereamong, bonding strength between the crystal lattice layers is low, because the ionic radius is small. Therefore, the inorganic layered compound is greatly swelled in water, and is preferably used in the present invention.

More specifically, a swellable inorganic layered compound, such as smectites (for example, natural smectites or synthetic smectites), swellable synthetic micas, and vermiculites, may be particularly preferably mentioned as the inorganic layered compound.

The smectite has a structure in which a tetrahedral sheet body in which an Si—O tetrahedron whose center is occupied by Si is extended over a plane and an octahedral sheet body whose center is occupied by a metal atom, such as Al or Mg, are formed normally at the ratio of 2:1. In the smectite, Si is substituted for Al in the tetrahedral sheet body, and Al is substituted for Mg in the octahedral sheet body. Therefore, in the crystalline layer of the smectite, a positive electric charge is insufficient, and a surface charge is negative. The tetrahedral sheet body is called a tetrahedral substitution type (tetrahedral charge type), to which, for example, beidelite, nontronite, volkonskoite, or saponite corresponds. The octahedral sheet body is called an octahedral substitution type (octahedral charge type), to which, for example, montmorillonite, hectorite, or stevensite corresponds.

Montmorillonite, saponite, and hectorite of the smectites, which are natural one, have been commercialized. Saponite, hectorite, and stevensite of the smectites, which are synthetic one, have also been commercialized.

For example, Na tetrasilicic mica NaMg_{2.5}(Si₄O₁₀)F₂, Na or Li taeniolite (NaLi)Mg₂Li(Si₄O₁₀)F₂, or Na or Li hectorite (NaLi)_{⅓}Mg_{⅔}Li_{⅓}(Si₄O₁₀)F₂ may be mentioned as a swellable synthetic mica.

In the inorganic layered compound, smectites and swellable synthetic micas, particularly swellable synthetic micas, are preferable from the viewpoint that the degree of swelling due to water is large, and it is easily cleaved in water so as to easily form a stable sol. The inorganic layered compound may be used as only one type of compound or as a combination of two or more kinds of compounds.

—Polymer—

No special limitation is imposed on the polymer as long as the inorganic layered compound may be preferably dispersed into the gas barrier layer. Since the surface of the inorganic layered compound is hydrophilic, it is preferable to use water-soluble polymers as a polymer from the viewpoint of dispersibility of the inorganic layered compound, and various synthetic, hydrophilic macromolecular materials may be mentioned as water-soluble polymers. For example, there are proteins such as gelatin, gelatin derivatives, graft polymers of gelatin and other high polymers, albumin, and casein; cellulose derivatives such as hydroxyethyl cellulose, carboxymethyl cellulose, and cellulose sulfates; sugar derivatives such as sodium alginate, pullulan, and starch derivatives; polyvinyl compounds such as polyvinyl alcohol, modifications of polyvinyl alcohol (for example, carboxy-denatured polyvinyl alcohol, silanol-denatured polyvinyl alcohol, and epoxy-denatured polyvinyl alcohol), copolymers of vinyl alcohol and other monomers such as ethylene-vinyl alcohol copolymers (EVAL), polyvinyl alcohol partial acetal, and poly-N-vinylpyrrolidone; polyacrylic acid compounds; polyamide compounds such as nylon; polymethacrylic acid compounds; and homopolymers or copolymers such as polyacrylamide. The polymers may be used as only one kind of polymer or as a combination of two or more kinds of polymers.

The polymers may be used as polymer latexes (alternatively, emulsions) while being dispersed in water.

For example, acrylic ester, methacrylate ester, crotonate, vinyl ester, diester maleate, diester fumarate, diester itaconate, acrylamides, methacrylamides, vinyl ethers, styrenes, vinylidene chlorides, acrylonitriles, and vinyl acetals may be mentioned as monomers that constitute the polymer latexes. The monomers may be used as only one kind of monomer or as a combination of two or more kinds of monomers.

Concrete examples of monomers are, methyl acrylate, ethyl acrylate, n-propyl acrylate, isopropyl acrylate, n-butyl acrylate, isobutyl acrylate, tert-butyl acrylate, hexyl acrylate, 2-ethylhexyl acrylate, acetoxyethyl acrylate, phenyl acrylate, 2-methoxy acrylate, 2-ethoxy acrylate, and 2-(2-methoxyethoxy)ethyl acrylate, etc., may be mentioned as the acrylic esters.

Methyl methacrylate, ethyl methacrylate, n-propyl methacrylate, n-butyl methacrylate, tert-butyl methacrylate, cyclohexyl methacrylate, 2-hydroxyethyl methacrylate, 2-ethoxyethyl methacrylate, etc., may be mentioned as the methacrylate ester.

Butyl crotonate, hexyl crotonate, etc., may be mentioned as the crotonate.

Vinyl acetate, vinyl propionate, vinyl butyrate, vinyl methoxyacetate, vinyl benzoate, etc., may be mentioned as the vinyl ester.

Diethyl maleate, dimethyl maleate, dibutyl maleate, etc., may be mentioned as the diester maleate.

Diethyl fumarate, dimethyl fumarate, dibutyl fumarate, etc., may be mentioned as the diester fumarate.

Diethyl itaconate, dimethyl itaconate, dibutyl itaconate, etc., may be mentioned as the diester itaconate.

Acrylamide, methylacrylamide, ethylacrylamide, propylacrylamide, n-butylacrylamide, tert-butylacrylamide, cyclohexyl acrylamide, 2-methoxyethylacrylamide, dimethyl acrylamide, diethylacrylamide, phenylacrylamide, etc., may be mentioned as the acrylamides.

Methylmethacrylamide, ethylmethacrylamide, n-butylmethacrylamide, tert-butylmethacrylamide, 2-methoxymethacrylamide, dimethyl methacrylamide, diethylmethacrylamide, etc., may be mentioned as the methacrylamides.

Methyl vinyl ether, butyl vinyl ether, hexyl vinyl ether, methoxyethyl vinyl ether, dimethylaminoethyl vinyl ether, etc., may be mentioned as the vinyl ethers.

Styrene, methyl styrene, dimethylstyrene, trimethylstyrene, ethylstyrene, isopropylstyrene, butylstyrene, chloromethylstyrene, methoxystyrene, butoxystyrene, acetoxystyrene, chlorostyrene, dichlorostyrene, bromostyrene, methyl vinyl benzoate, 2-methylstyrene, etc., may be mentioned as the styrenes.

Homopolymers or copolymers may be used as polymer latexes composed of monomers, for which acrylic esters, methacrylate esters, styrenes, acrylate/methacrylate biopolymers or terpolymers, styrene-butadiene copolymers, polyvinylidene chlorides, polyesters, polyvinyl acetals, and polyacrylonitriles are particularly suitable from the viewpoint of film productivity, transparency, and gas barrier properties.

Preferably, the polymer has a refractive index close to that of the inorganic layered compound to be dispersed. For example, when the swellable, synthetic mica (refractive index: approximately 1.53) is used as the inorganic layered compound, it is particularly preferable to use gelatin (refractive index: 1.53 to 1.54) or gelatin derivatives as the polymer to be used together.

If the gelatin or the gelatin derivatives are used as the polymer, a gas barrier layer may be formed as a result of gelation by application/cooling. Therefore, the resulting gas barrier layer has no irregularity, and is superior in optical properties and in gas barrier properties.

For example, acid-processed gelatin as well as lime-processed gelatin, a hydrolyzed product of gelatin, and an enzyme-degraded product of gelatin may be mentioned as the gelatin. Products obtained by reacting gelatin with various compounds, for example, acid halide, acid anhydride, isocyanates, bromoacetic acid, alkane sultones, vinyl sulfonamides, maleinimide compounds, polyalkylene oxides, and epoxy compounds may be mentioned as the gelatin derivatives.

It is preferable to use a crosslinking agent for the cross-linkage to the polymer in order to form the gas barrier layer. In this case, preferably, the polymer has at least one functional group selected from among carboxyl group, amino group, ammonium base, hydroxy group, sulfine group (alternatively, base thereof), sulfonic acid group (alternatively, base thereof), and glycidyl group.

For example, vinyl sulfone-based compound, aldehyde-based compound (for example, formaldehyde, glutaraldehyde), epoxy-based compound, oxazine-based compound, triazine-based compound, high-polymer hardening agent cited in Japanese Patent Application Laid-Open No. S62-234157, methylate melamine, blocked isocyanate, methylol compound, and carbodiimide resin may be mentioned as the crosslinking agent.

The vinyl sulfone-based compound, the aldehyde-based compound, the epoxy-based compound, the oxazine-based compound, the triazine-based compound, and the high-polymer hardening agent cited in Japanese Patent Application Laid-Open No. S62-234157 are suitable among these crosslinking agents.

Specific examples of the crosslinking agents will be shown below.

A compound having two functional groups or more may be mentioned as the epoxy compound. For example, there are dibromophenyl glycidyl ether, dibromoneopentyl glycol diglycidyl ether, an emulsion of an epoxy cresol novolak resin, a denatured bisphenol A-type epoxy emulsion, adipic acid diglycidyl ester, o-phthalate diglycidyl ester, hydroquinone diglycidyl ether, bisphenol S glycidyl ether, telephthalate diglycidyl ether, glycidyl phthalimide, propylene polypropylene glycol diglycidyl ether, polytetramethylene glycol diglycidyl ether, arylglycidyl ether, 2-ethylhexylglycidyl ether, phenylglycidyl ether, phenol (EO)₅ glycidyl ether, p-tertiary butylphenylglycidyl ether, lauryl alcohol (EO)₁₅ glycidyl ether, glycidyl ether formed by an alcohol mixture having 12 to 13 carbon atoms, glycerol polyglycidyl ether, trimethylolpropanepolyglycidyl ether, resorcinol diglycidyl ether, neopentylglycoldiglycidyl ether, 1,6-hexandiolediglycidyl ether, ethylene polyethylene glycol diglycidyl ether, sorbitolpolyglycidyl ether, sorbitan polyglycidyl ether, polyglycerol polyglycidyl ether, pentaerythritol polyglycidyl ether, diglycerol polyglycidyl ether, and triglycidyl-tris (2-hydroxyethyl) isocyanurate. Among these epoxy compounds, glycidyl ethers are particularly suitable.

Preferably, an effective epoxy equivalent to epoxy compound ranges from 70 to 1,000 WPE. When the epoxy equivalent is more than 1,000 WPE, it becomes difficult to possess water resistance.

The blocked isocyanate refers to a compound in which a terminal isocyanate group of isocyanate is masked by a blocking agent. Examples of the blocked isocyanate include: (a) a compound in which a blocking body of a hydrophilic group which is comprised of a carbamoil sulfonate group (—NHCOSO₃—) is formed at the terminal end of an isocyanate compound so that an active isocyanate group is blocked, (b) a compound in which an active isocyanate group is blocked by using isopropyliden malonate (this blocked isocyanate is obtained through the reaction between HDI isocyanulate, isopropylidenmalonate, and triethylamine), (c) a compound in which an active isocyanate group is blocked by phenols, and the like.

The blocked isocyanate is mixed with, for example, the silanol-denatured polyvinyl alcohol, and is heated so that the quality of the silanol-denatured polyvinyl alcohol improves through a crosslinking, thereby achieving water resistance for the silanol denatured polyvinyl alcohol.

Compounds disclosed in Japanese Patent Application Laid-Open Nos. S53-57257 and S53-412221, and Japanese Patent Application Publication Nos. S49-13563 and S47-24259 may be mentioned as the vinyl sulfone-based compounds.

Monoaldehyde such as formaldehyde and acetaldehyde, and polyhydric aldehyde such as glyoxalin, glutaraldehyde, and dialdehyde starch may be mentioned as the aldehyde-based compounds.

Methylolmelamine, dimethylol carbamide, etc., may be mentioned as the methylol compounds.

When the silanol denatured polyvinyl alcohol is used as the polymer, the aldehyde-based compound is particularly suitable as a crosslinking agent.

Preferably, the amount of crosslinking agent used for the polymer ranges from 1 to 50 mass parts with respect to the polymer in an amount of 100 mass parts.

If the amount of mixture of the cross-linking agent is less than 1 mass part, the degree of quality improvement through the reaction of crosslinking is low so that the cross-linking agent cannot provide the gas barrier layer with sufficient water resistance and chemical resistance, whereas, if the amount of mixture of the cross-linking agent is more than 50 mass parts, there is the possibility that liquid stability will deteriorate when the gas barrier layer is formed.

If the surface of the inorganic layered compound has undergone hydrophobic processing, a hydrophobic polymer may be preferably used as the polymer. Since the surface thereof has, as mentioned above, a negative charge, the inorganic layered compound adsorbs compounds that have cationic groups. Therefore, it is preferable to hydrophobicize the surface of the inorganic layered compound by adsorbing a cationic compound having hydrophobic groups, for example, a quaternary surfactant (for example, according to the method of Japanese Patent Application Laid-Open No. H6-287014). The inorganic layered compound whose surface has become hydrophobic is preferably swelled by an organic solvent combinative to the hydrophobic groups.

Publicly known hydrophobic polymers may be mentioned as known hydrophobic polymers. For example, there are vinylidene chloride resin, vinyl chloride resin, acrylonitrile resin, nylon resin, polyester resin, polycarbonate resin, polyurethane resin, phenol resin, polyamide resin, acrylic resin, styrene resin, diallyl phthalate resin, epoxy resin, and polyacetal resin. The hydrophobic polymer may be used as one kind of polymer or as a combination of two or more kinds of polymers.

Preferably, the polymer has high gas barrier properties. Specifically, polyvinyl alcohol and its modifications, ethylene-vinyl alcohol copolymer (EVAL), nylon resin, vinylidene chloride resin, acrylonitrile resin, polyester resin, polycarbonate resin, and gelatin and its derivatives may be preferably mentioned as polymers having high gas barrier properties. Among them, polyvinyl alcohol, its modifications that contain 70% or more vinyl alcohol, and vinylidene chloride resin are particularly preferable as a monomer unit from the viewpoint of being superior in gas barrier properties. From the viewpoint of adhesive properties with a contiguous layer, carboxyl-denatured polyvinyl alcohol, silanol-denatured polyvinyl alcohol, and epoxy-denatured polyvinyl alcohol are most preferable among the polyvinyl alcohols. From the viewpoint of water resistance, ethylene-vinyl alcohol copolymer (EVAL), silanol-denatured polyvinyl alcohol, and hydrophobic-group-denatured polyvinyl alcohol are most preferable. Preferably, insoluble compounds among the polymers are used as the polymer latex (alternatively, emulsion).

<Various Physical Properties of Gas Barrier Layer>

Concerning the size of the inorganic layered compound in the gas barrier layer, the thickness is preferably 1 to 50 nm, and, more preferably, 2 to 10 nm. The surface size is preferably 20 to 200,000 nm, and, more preferably, 40 to 20,000 nm. The aspect ratio is preferably 10 to 5,000, more preferably, 20 to 5,000, much more preferably, 40 to 3,000, and, most preferably, 100 to 3,000. If the aspect ratio is less than 10, gas barrier properties in the gas barrier layer may be lowered.

The content of the inorganic layered compound in the gas barrier layer is preferably 10 to 300 mg/m², more preferably, 20 to 200 mg/m², and, much more preferably, 30 to 150 mg/m². Gas barrier properties in the gas barrier layer will become insufficient if the content of the inorganic layered compound therein is less than 10 mg/m², whereas the transparency in the gas barrier layer may be lowered or the haze may increase if it exceeds 300 mg/m².

The oxygen transmission rate of the gas barrier layer (under the temperature of 40° C., humidity: 90%) is preferably 0.5 ml/m²·atm·day or less, and, more preferably, 0.2 ml/m²·atm·day or less.

If the oxygen transmission rate is within this value, the gas barrier layer can have sufficient gas barrier properties.

This oxygen transmission rate is one that has been calculated by a gas transmission rate-measuring device (made by Mokon Inc.).

<Formation of Gas Barrier Layer>

No special limitation is imposed on the method for forming the gas barrier layer. The layer may be formed as follows. For example, the inorganic layered compound is added while stirring a solvent such as water, and is fully adjusted to the solvent. Thereafter, the inorganic layered compound is swelled, and is dispersed with a disperser so as to obtain a dispersed liquid. The dispersed liquid is added into a dispersed material of the polymer, is then stirred, and is applied onto the plastic film, thus forming the gas barrier layer.

Since the surface of the inorganic layered compound is normally hydrophilic, the inorganic layered compound may be easily swelled in water, and is easily dispersed by sharing it. In this method, an organic solvent, which is mixable with water, such as dimethyl sulfoxide, dimethyl formamide, and acetone, may be added, if necessary, as well as alcohols such as methanol, ethanol, propanol, isopropanol, ethylene glycol, and diethylene glycol.

In the case where the surface thereof is hydrophobicized with, for example, a quaternary surfactant, the gas barrier layer may be formed as follows. For example, the inorganic layered compound that has been subjected to hydrophobic processing is fully adjusted to an organic solvent, such as toluene, xylene, methylethyl ketone, acetone, methyl isobutyl ketone, propanol, isopropanol, quaternary carbon, perchloroethylene, methyl cellosolve, and dimethyl formamide, is then swelled, dispersed with the disperser, and applied onto the plastic film.

Various mills for dispersion by direct, mechanical power, high-speed stirring dispersers that have high shearing power, and dispersers that apply superhigh ultrasonic energy may be used as the disperser. Specifically, a ball mill, a sand grinder mill, a visco mill, a colloid mill, a homogenizer, a dissolver, a Polytron, a homomixer, a homoblender, a Keddy mill, a jet agitator, a capillary emulsifying apparatus, a liquid siren, an electromagnetic skewing ultrasonic wave generator, and an emulsifying apparatus equipped with a Paulman whistle may be mentioned as the disperser. The dispersion obtained by being dispersed by the disperser has high viscosity or is in a gel state and has extremely good storage stability. Preferably, the inorganic layered compound is diluted with water or with a solvent, and is sufficiently stirred when this compound is added after a coating solution for a gas barrier layer is applied onto the plastic film.

The thickness of the gas barrier layer is preferably 0.1 to 10 μm, and, more preferably, 1 to 2 μm. If it is less than 0.1 μm, gas barrier properties in the gas barrier layer will become insufficient, and, in contrast, if it exceeds 10 μm, the display substrate will be insufficient for reductions in thickness and in weight.

[Plastic Film]

No special limitation is imposed on the plastic film as long as the average light transmittance in wavelengths of 400 to 700 nm is 70% or more, and the glass transition point is 100° C. or more. However, preferably, they are appropriately selected according to, for example, a purpose for using the display substrate, as follows.

<Use of Display Substrate Superior in Optical Isotropy>

When the display substrate of the present invention is used as a display substrate superior in optical isotropy (i.e., a display substrate whose retardation (Re) in a wavelength of 632.8 nm is 15 nm or less), a film made of known polymer materials, such as polyethersulfone (PES), polycarbonate (PC), polyarylate (PAr), norbornane, polyester, and epoxy butadiene copolymer, may be used as the plastic film. In this plastic film, the materials may be used as one kind of material or as a combination of two or more materials. A film having a laminated structure may be formed by using two or more kinds of materials, and a copolymer of monomers made of the materials may be formed. Among these materials, norbornane polymers are preferable from the viewpoint that the occurrence of transparency/birefringence is low.

<Use of Display Substrate for STN Liquid Crystal Display>

When the display substrate of the present invention is used as a display substrate for use in the STN (supertwisted nematic) liquid crystal display, all films that are made of the materials mentioned in “Use of display substrate superior in optical isotropy” may be preferably used as the plastic film. Among these materials, polycarbonate resins, polyethersulfone resins, and polyarylate resins are preferable from the viewpoint of transparency, birefringence, and wavelength dispersion. When used as the display substrate for the STN liquid crystal display, the plastic film can advantageously employ the lamination of different types of polymers in order to control the wavelength dispersion of retardation (Re) more exactly. From the viewpoint of costs, coextrusion is suitable for the lamination. No special limitation is imposed on a preferable combination of the different types of polymers as long as they are combined so that the wavelength dispersion becomes different. For example, the wavelength dispersion of retardation (Re) may be freely controlled within a wide range by combining polymers that are large and small in wavelength dispersion and whose intrinsic birefringence values have the same signs. Further, by causing the intrinsic birefringence values of the different types of polymers to have different signs, a large wavelength dispersion unobtainable when the polymer is used alone, may be obtained,

<Use of Quarter-wave Plate>

Preferably, when the display substrate of the present invention is used as the quarter-wave plate, the plastic film is a phase difference plate that satisfies the relation Re(450)<Re(550)<Re(650) wherein Re(450), Re(550), and Re(650) are retardation values in wavelengths 450 nm, 550 nm, and 650 nm, respectively. In other words, preferably, the retardation values and the wavelengths have a positive correlation within the numerical range of the wavelengths. This correlation makes it possible to have a constant phase difference characteristic with respect to incident light in a visible light range and to provide a display substrate suitable for black-and-white presentation or for color presentation.

When the display substrate of the present invention is used as the quarter-wave plate, the values of “retardation (Re)/wavelength (λ)” in wavelengths 450 nm, 550 nm, and 650 nm of the plastic film are preferably 0.2 to 0.3, more preferably, 0.23 to 0.27, and, much more preferably, 0.24 to 0.26, though the values slightly vary according to, for example, the properties of liquid crystals to be used. If the value of “retardation (Re)/wavelength (λ)” is in the aforementioned numerical range, a wide-band ¼ phase difference plate is provided which has more uniform phase difference characteristics with respect to incident light in the whole visible light range.

When the display substrate of the present invention is used as the quarter-wave plate, preferred aspects of the plastic film are, for example, a first aspect that includes materials whose intrinsic birefringence value is positive and materials whose intrinsic birefringence value is negative, a second aspect that includes a laminated structure of a layer made of materials whose intrinsic birefringence value is positive and a layer made of materials whose intrinsic birefringence value is negative, a third aspect that includes materials that have a part whose intrinsic birefringence value is positive and a part whose intrinsic birefringence value is negative, a fourth aspect that uses materials disclosed in International Publication No. WO00/26705, and a fifth aspect that uses cellulose acetate, and, accordingly, aspects that have quarter-wave plate characteristics in a wide band by one plate are also effective. In the present invention, the aspect which uses a combination of materials whose intrinsic birefringence value is positive and negative is particularly preferable since photoelasticity becomes small.

<<First Aspect>>

In the first aspect, the plastic film includes a first material whose intrinsic birefringence value is positive and a second material whose intrinsic birefringence value is negative (which means that the positive and negative materials are included in the same layer), and, if necessary, includes other components.

—Materials whose Intrinsic Birefringence Value is Positive—

Materials whose intrinsic birefringence value is positive are ones that have a characteristic showing an optically positive uniaxiality when a uniaxial orientation rule is given to molecules. Polymers, rod-like liquid crystals, and rod-like liquid crystalline polymers may be mentioned as examples of these materials. These may be used as one kind or as a combination of two or more kinds. Among them, polymers whose intrinsic birefringence value is positive are preferred in the present invention.

For materials whose intrinsic birefringence value is positive, examples of polymers whose intrinsic birefringence value is positive include polyolefin polymers (for example, polyethylene, polypropylene, and norbornane polymers), polyester polymers (for example, polyethylene terephthalate and polybutylene terephthalate), polyarylene sulfide polymers (for example, polyphenylene sulfide), polyvinyl alcohol polymers, polycarbonate polymers, polyarylate polymers, cellulose ester polymers (whose intrinsic birefringence value is negative), polyethersulfone polymers, polysulfone polymers, polyallyl sulfone polymers, polyvinyl chloride polymers, and multiple (dual, ternary, etc.) copolymerized polymers thereof. These polymers may be used as one kind or as a combination of two or more kinds. Among the aforementioned polymers, polycarbonate polymers such as denatured polycarbonates, norbornane polymers, and polyethersulfone polymers are preferable in the present invention, from the viewpoint of heat resistance and transparency.

Rod-like liquid crystals which show nematic orientation may be preferably mentioned as the rod-like liquid crystals, and they may be low-molecular or high-molecular liquid crystals.

Specific examples of the low-molecular liquid crystals include azomethines, azoxys, cyanobiphenyls, cyanophenyl esters, benzoates, cyclohexanecarboxylic acid phenyl esters, cyanophenyl cyclohexanes, cyano-substituted phenyl pyridines, phenyl dioxanes, tolanes, and alkenyl cyclohexyl benzonitriles.

—Materials whose Intrinsic Birefringence Value is Negative—

Materials whose intrinsic birefringence value is negative are ones that have a characteristic showing an optically negative uniaxiality when a uniaxial orientation rule is given to molecules. Polymers, disk-like liquid crystals, and disk-like liquid crystalline polymers may be mentioned as examples of these materials. These may be used as one kind or as a combination of two or more kinds. Among them, polymers whose intrinsic birefringence value is negative are preferred in the present invention.

For materials whose intrinsic birefringence value is negative, examples of polymers whose intrinsic birefringence value is negative include polystyrene polymers, polyacrylonitrile polymers, polymethyl methacrylate polymers, cellulose ester polymers such as cellulose acetates (some of which have positive intrinsic birefringence values), and multiple (i.e., dual, ternary, etc.) copolymerized polymers thereof. These polymers may be used as one kind or as a combination of two or more kinds. In the present invention, among the aforementioned polymers, polystyrene polymers are preferable from the viewpoint of the occurrence of birefringence, and styrene and maleic anhydride copolymers are more preferable, especially from the viewpoint of heat resistance.

Preferably, materials whose intrinsic birefringence values are positive and materials whose intrinsic birefringence values are negative have significant difference in wavelength dispersion while sharing large retardation (Re) occurrence.

Styrenic materials may be preferably mentioned as materials whose intrinsic birefringence value is negative and have large occurrence of retardation (Re). Since the styrenic materials are large in wavelength dispersion, materials small in wavelength dispersion are preferred as materials to be combined whose intrinsic birefringence values are positive. Olefinic and polyvinyl-alcoholic polymers may be mentioned as materials small in wavelength dispersion. From the viewpoint of heat resistance and scale stability, cycloolefin polymers, such as norbornane polymers, are particularly preferable.

Other Components—

No special limitation is imposed on other components that are contained in the plastic film as long as the components do not lessen the effect of the present invention. The components may be appropriately selected in accordance with an object. For example, a compatibilizer may be preferably used. For example, in a case where phase separation occurs when the materials whose intrinsic birefringence value is positive are mixed with materials whose intrinsic birefringence value is negative, the compatibilizer may be preferably used. By using the compatibilizer, the positive materials and the negative materials are mixed well.

—Manufacture of Plastic Film in the First Aspect—

No special limitation is imposed on manufacturing methods of the plastic film in the first aspect, and they may be appropriately selected in accordance with an object. For example, the positive and negative materials are appropriately selected, the compounding ratio thereof is then determined, the compatibilizer is then added if necessary, and they are mixed to obtain a mixture. Thereafter, the mixture is dissolved in a liquid, is then applied, dried, and molded using a solution film formation method. Alternatively, an extrusion molding method may be utilized in which the mixture is pelleted, is then subjected to melt extrusion, and is molded. A film-like or sheet-like piece is molded according to these methods, and the value of the retardation (Re) is appropriately controlled by stretching so as to fall within the aforementioned numerical range, thereby manufacturing the plastic film in the first aspect. Longitudinally uniaxial stretching in which a film is stretched in the direction of a mechanical flow and laterally uniaxial stretching in which a film is stretched in the direction orthogonal to the mechanical flow (for example, tenter stretching) may be preferably utilized as the method of stretching. Biaxial stretching may also be employed to some extent.

<<Second Aspect>>

The second aspect is one in which the plastic film has a laminated body comprising a layer made of materials whose intrinsic birefringence value is positive, a layer made of materials whose intrinsic birefringence value is negative, and, if necessary, other layers.

The same materials as those mentioned in “First aspect” may all be mentioned as materials whose intrinsic birefringence values are positive and materials whose intrinsic birefringence values are negative. For more preferable materials, the same materials as those mentioned in the first aspect may be applied.

An example of another layer is an adhesive layer by which the layer made of materials whose intrinsic birefringence value is positive may preferably adhere to a layer made of materials whose intrinsic birefringence value is negative.

—Manufacturing of Plastic Film in the Second Aspect—

No special limitation is imposed on manufacturing methods of the plastic film in the second aspect. From the viewpoint of easy manufacturing of the laminated structure, a manufacturing method of subjecting the materials whose intrinsic birefringence values are positive and negative to coextrude is preferred.

For example, in the coextrusion, polymers whose intrinsic birefringence value is positive, polymers whose intrinsic birefringence value is negative, and, if necessary, polymers for use in an adhesive layer are guided to the inside of an extruding die, the polymers are then brought into contact with each other in the inside of the die or at the opening thereof, and are united to form a laminated body.

No special limitation is imposed on the die. A T-die may be preferably used. No limitation is imposed on the internal shape of the T-die, and variously shaped dies may be used. If necessary, the extruded laminated body that is in a molten state is stretched onto a plurality of rolls, and is moved according to the rotation of the rolls. Thereby, the thickness of the laminated body may be adjusted to the desired thickness.

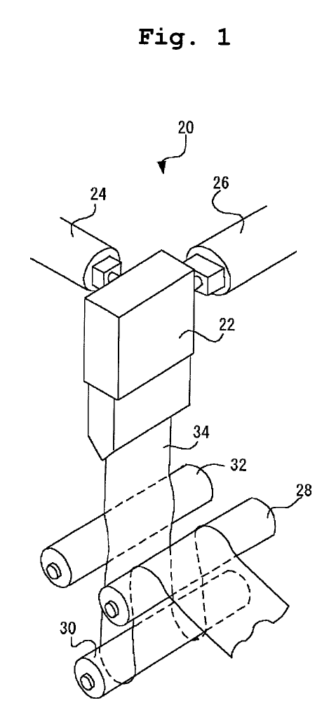

FIG. 1 shows the schematic structure of a coextruder preferably used for the coextrusion.

The coextruder 20 includes an extruding die 22, extruding containers 24 and 26, and stretch rolls 28, 30, and 32. In the coextruder 20, polymers whose intrinsic birefringence values are positive and negative and that have been contained in the extruding containers 24 and 26 are guided to the inside of the extruding die 22, and are mixed at the opening of the extruding die 22. Thereafter, the polymers are brought into contact with each other, and are united so as to form a laminated body 34. If adhesion is low between the polymers whose intrinsic birefringence value is positive and the polymers whose intrinsic birefringence value is negative, an extruding container used to form an adhesive layer may further be provided.

The laminated body 34 obtained here is stretched by the rotating stretch rolls 28, 30, and 32, is then moved according to the rotation of the stretch rolls 28, 30, and 32, and is adjusted to the desired thickness to be shaped like a film or like a sheet. Thereafter, the value of retardation (Re) is appropriately controlled to fall within the aforementioned numerical range, thereby manufacturing the plastic film in the second aspect. The same stretching as that mentioned in “Manufacture of plastic film in the first aspect” is preferably performed in the second aspect.

<<Third Aspect>>

The third aspect is one in which the plastic film has materials including a part whose intrinsic birefringence value is positive, a part whose intrinsic birefringence value is negative, and, if necessary, other components.

—Materials Including a Part whose Intrinsic Birefringence Value is Positive and a Part whose Intrinsic Birefringence Value is Negative—

A copolymerization composition that includes a chain showing the positive uniaxiality and a chain showing the negative uniaxiality when a uniaxial orientation rule is given is suitable as materials including a part whose intrinsic birefringence value is positive and a part whose intrinsic birefringence value is negative. A copolymerization composition of monomers that constitute polymers whose intrinsic birefringence value is positive and monomers that constitute polymers whose intrinsic birefringence value is negative is particularly suitable as materials. No special limitation is imposed on the copolymerization composition. However, preferably, the copolymerization composition is a graft copolymer that includes a principal chain and a graft chain linked to the principal chain in the form of graft linkage, and, particularly preferably, the principal chain is one that consists of monomers that constitute polymers whose intrinsic birefringence value is positive, and the graft chain is one that consists of monomers that constitute polymers whose intrinsic birefringence value is negative. The same polymers as those mentioned in the first aspect may be preferably mentioned as polymers positive and negative in the intrinsic birefringence value. The same applies to especially preferable polymers.

No limitation is imposed on the manufacturing method for the graft copolymer. Examples of the manufacturing method include known polymerization methods, such as block polymerization, precipitation polymerization, emulsion polymerization, solution polymerization, and suspension polymerization. Among them, suspension polymerization or solution polymerization is preferred.

When suspension polymerization is performed, reference may be made to, for example, p. 130 and pp. 146-147 of “Experimentation of polymer synthesis” (Takayuki Otsu, Masaetsu Kinoshita in collaboration; Kagaku Dojin Publishing). According to suspension polymerization, with the presence of inorganic salts and/or a water-soluble polymer dispersing agent, the graft copolymer may be obtained in the form of particles of 50 μm or more by the addition-polymerization reaction actuated by an oil soluble initiator by use of an aqueous dispersion medium.

Inorganic salts are used for the purpose of dispersion stabilization, prevention of monomers from being dissolved in water, and the like. Examples of inorganic salts are sodium chloride, potassium chloride, calcium chloride, magnesium chloride, ammonium chloride, potassium sulfate, calcium sulfate, magnesium sulfate, ammonium sulfate, aluminum potassium sulfate, sodium carbonate, potassium carbonate, and calcium hydrogen phosphate.

Examples of water-soluble polymer dispersing agents are polyvinyl alcohol, polyacrylic soda, alkaline hydrolyzate of styrene-maleic anhydride copolymer (for example, “Isoban” made by Kuraray), sodium alginate, and water-soluble cellulose derivatives (for example, “Meyprogat”, “Kelco SCS”, and “Guar gum” made by Sansho; “MH-K” made by Hoechst Japan).

Preferably, a water-insoluble and oil-soluble initiator is used as the initiator for the suspension polymerization. Examples of the initiator include azo bis(cyclohexane-1-carbonitrile), azobisisobutyronitrile, 2,2′-azobis(2,4-dimethyl valeronitrile), 2,2′-azobis(4-methoxy-2,4-dimethyl valeronitrile), 2,2-azobis isobutyric acid dimethyl, benzoyl peroxide, lauroyl peroxide, tert-butyl peroxide, tert-amyl peroxide, cumyl peroxide, t-butyl benzoate peroxide, t-butyl phenylacetate peroxide. Among them, a peroxide-based initiator is preferred.

Polymerization temperature during graft polymerization depends on the kind, boiling point, and ceiling temperature (i.e., temperature at which polymerization and depolymerization reach equilibrium) of monomers for which the graft polymerization is performed. Normally, it is 0 to 100° C., and, preferably, 40 to 90° C., though this temperature cannot be fixedly determined.

—Other Components—

Preferably, the same components as those mentioned in the first aspect are used as other components to be contained in the plastic film.

—Manufacture of Plastic Film in the Third Aspect—

No special limitation is imposed on manufacturing methods of the plastic film in the third aspect. The manufacturing method may be appropriately selected in accordance with an object. For example, materials that include parts positive and negative in the intrinsic birefringence value are appropriately selected, a compatibilizer is then added if necessary, and they are mixed to obtain a mixture. Thereafter, the mixture is dissolved in a liquid, is then applied, dried, and molded. This is a solution film formation method. Additionally, an extrusion molding method may be mentioned in which the mixture is pelleted, is then subjected to melt extrusion, and molded. A film-like or sheet-like piece is molded according to these methods, and the value of the retardation (Re) is appropriately controlled to fall within the aforementioned numerical range, thereby manufacturing the plastic film in the third aspect. Preferably, the same stretching as that mentioned in “Manufacture of plastic film in the first aspect” is performed in this aspect.

<Physical Properties of Plastic Film>

The photoelasticity of the plastic film is preferably 20 Brewster or less, and, more preferably, 5 Brewster or less.

If the photoelasticity exceeds 20 Brewster, birefringence occurs because of a distortion caused when stress is applied onto the plastic film. Disadvantageously, this causes light leakage or the like.

No special limitation is imposed on the thickness of the plastic film. Preferably, it is 30 to 500 μm from the viewpoint of reductions in film thickness and in weight. More specifically, when the display substrate of the present invention is used as a display substrate superior in optical isotropy, it is preferably 80 to 500 μm, and, more preferably, 100 to 300 μm. When the display substrate of the present invention is used as a display substrate for an STN liquid crystal display, it is preferably 80 to 500 μm, and, more preferably, 100 to 200 μm. When the display substrate of the present invention is used as a quarter-wave plate, it is preferably 30 to 300 μm, and, more preferably, 50 to 200 μm. If the thickness of the plastic film exceeds the aforementioned ranges, the reductions in film thickness and in weight cannot be sufficiently realized.

[Other Members]

Examples of other members are a hard coating layer, a protective layer, an adhesion layer, a transparent conductive layer, and a color filter.

Epoxy resins, epoxy acrylate, SiO₂, SiₓO, Al₂O₃, Si₃O₄, TiO₂, AIN, ZnO, ZnS, ZrO₂, SiC, Si:O:N, Si:O:H, Si:N:H, and Si:O:N:H may be mentioned as materials of the hard coating layer, the protective layer, and the adhesion layer.

Preferably, the hard coating layer and the adhesion layer are disposed on the gas barrier layer.

Known materials such as ITO (indium tin oxide) may be mentioned as materials of the transparent conductive layer. Preferably, the transparent conductive layer is disposed on the hard coating layer and the adhesion layer.

Known color filter materials, such as dye materials (dyeing: photo litho, dye dispersion: etching), pigmentary materials (photo litho, etching, printing, electrodeposition, and vapor deposition), metallic oxide materials, and cholesteric liquid crystal materials may be mentioned as materials of the color filter. Preferably, the color filter is disposed between the hard coating layer, the adhesion layer, and the transparent conductive layer.

<Use and Physical Properties of Display Substrate>

No special limitation is imposed on the use of the display substrate of the present invention. Particularly preferred examples are use for the display substrate superior in optical isotropy, use for the display substrate of the STN liquid crystal display, and use for the quarter-wave plate, as described above.

In the use for the display substrate superior in optical isotropy, the value of retardation (Re) in a wavelength of 632.8 nm is preferably 15 nm or less, and, more preferably, 10 nm or less in the display substrate of the present invention.

In the use for the display substrate of the STN liquid crystal display, the value of retardation (Re) in a wavelength of 632.8 nm is preferably either within the range of 250 to 450 nm or within the range of 500 to 650 nm in the display substrate of the present invention, from the viewpoint that STN liquid crystals may be preferably compensated. When the value of retardation (Re) satisfies the former range, the STN liquid crystals may be preferably compensated with two display substrates, and, when the value of retardation (Re) satisfies the latter range, the STN liquid crystals may be preferably compensated with one display substrate.

<Structure of Display Substrate>

Preferably, the structure of the display substrate of the present invention is formed to have the gas barrier layer on both surfaces of the plastic film, from the viewpoint of gas barrier properties, strength, and curl prevention. Further, when the display substrate of the present invention is used for a liquid crystal display, it is particularly preferable to dispose the gas barrier layer at least on the surface on the side in contact with liquid crystal cells.

According to the present invention described above, one plastic film may be substantially used as a display substrate, while the conventional display substrate has been developed by a combination of a glass substrate, a phase difference film for STN, and a quarter-wave plate. Therefore, the display substrate of the present invention is easily reduced in weight and in thickness, is capable of withstanding large shocks, is superior in planarity and in adhesive properties to ITO electrodes, easily manufactured, superior in gas barrier properties, and capable of exhibiting high performance in a wide band. Therefore, the display substrate of the present invention is applicable to display devices in various fields.

Embodiments of the present invention will be described as follows, to which the present invention is not limited.

(Embodiment 1)

—Manufacture of Display Substrate—

8 mass parts of a swellable inorganic layered compound (swellable synthetic mica: ME-100 (made by Co-op Chemical) were added to water (100 mass parts) while being stirred, and were fully adjusted to water, and were swelled. Thereafter, they were fully dispersed in a disperser (Visco mill made by Aimex Inc.). They were added into gelatin 5 weight % water solution 500 mass parts of 40° C., and were stirred for 30 minutes, thus preparing an applying liquid for a gas barrier layer. The resultant applying liquid was applied onto the surface of a plastic film (materials: polycarbonate; average light transmittance in wavelengths of 400 to 700 nm: 89%; glass transition point: 145° C.), thereby forming a gas barrier layer (thickness: 2 μm). A display substrate was manufactured in this way.

<Measurement of Value of Retardation (Re)>

In the obtained display substrate, the value of retardation (Re) in a wavelength of 632.8 nm was measured with a retardation measurer (“KOBRA-21ADH” made by Oji Scientific Instruments). The value was 380 nm, which was suitable for a display substrate of an STN liquid crystal display.

<Measurement of Oxygen Transmission Rate>

In the obtained display substrate, the oxygen transmission rate was measured with a gas-transmission-rate-measuring device (made by Mokon). The rate was 0.3 ml/m²·atm·day, which showed excellent gas barrier properties.

(Embodiment 2)

—Manufacture of Display Substrate—

Except for the fact that the plastic film used in “manufacture of display substrate” of Embodiment 1 was substituted with a plastic film (materials: norbornane (made by Zeon Japan; Seonoa 1600), average light transmittance in wavelengths of 400 to 700 nm: 92%, glass transition point: 160° C.), a display substrate in which a gas barrier layer (thickness: 2 μm) was formed on a plastic film was manufactured in the same way as in Embodiment 1.

<Measurement of Value of Retardation (Re)>

In the obtained display substrate, the value of retardation (Re) in a wavelength of 632.8 nm was measured in the same way as in Embodiment 1. The value was 3 nm, which was superior in optical isotropy.

<Measurement of Oxygen Transmission Rate>

In the obtained display substrate, the oxygen transmission rate was measured in the same way as in Embodiment 1. The rate was 0.3 ml/m²·atm·day, which showed excellent gas barrier properties.

(Embodiment 3)

—Manufacture of Plastic Film—

16 mass parts of norbornane resins (made by JSR; Arton “F”) (whose intrinsic birefringence value is positive) and 11 mass parts of copolymers of styrene and maleic anhydride (made by Sekisui Chemical; “Dilark 232”) (whose intrinsic birefringence value is negative) were dissolved in toluene, thereby preparing an applying liquid (27 weight %). The applying liquid was poured onto a glass plate with a doctor blade, and was dried, thereby obtaining a transparent film (thickness: 120 μm). This transparent film was subjected to 35% uniaxial stretching at 125° C., thereby manufacturing a plastic film.

<Measurement of Wavelength Dispersion in Plastic Film>

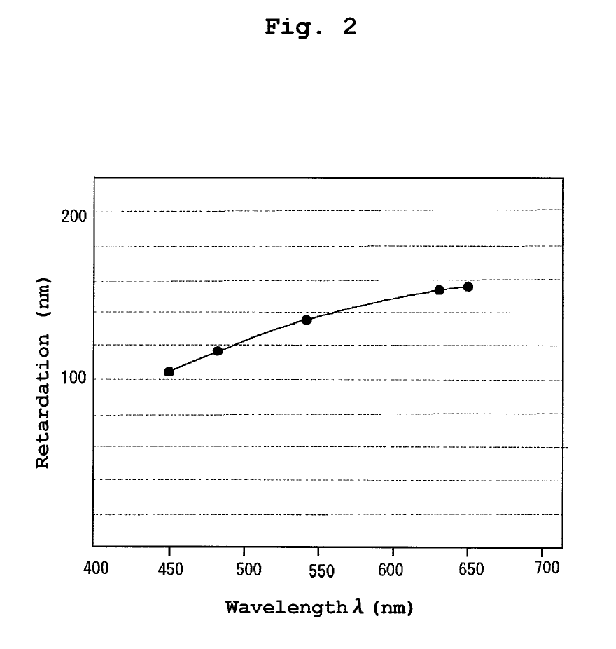

In the obtained plastic film, the wavelength dispersion of retardation (Re) was measured with the retardation measurer (“KOBRA-21ADH” made by Oji Scientific Instruments). The results are shown in FIG. 2. As shown in FIG. 2, the plastic film that had been manufactured in Embodiment 3 satisfied the relation Re(450)<Re(550)<Re(650) wherein Re(450), Re(550), and Re(650) are retardation (Re) values in wavelengths 450 nm, 550 nm, and 650 nm, respectively. As a result, it was understood that the film has excellent quarter-wave plate characteristics in a wide band. The average light transmittance in wavelengths of 400 to 700 nm of the plastic film was 90%, and the glass transition point was 155° C.

—Manufacture of Display Substrate—

Except for the fact that the plastic film used in “manufacture of display substrate” of Embodiment 1 was substituted with the plastic film made in Embodiment 3 (average light transmittance in wavelengths of 400 to 700 nm: 90%; glass transition point: 155° C.), a display substrate in which a gas barrier layer (thickness: 2 μm) was formed on the plastic film was manufactured in the same way as in Embodiment 1.

<Measurement of Oxygen Transmission Rate>

In the obtained display substrate, the oxygen transmission rate was measured in the same way as in Embodiment 1. The rate was 0.3 ml/m²·atm·day, which showed excellent gas barrier properties.

What is claimed is:

1. A display substrate comprising:
a plastic film whose average light transmittance in wavelengths of 400 to 700 nm is 70% or more and whose glass transition point is 100° C. or more; and
a gas barrier layer containing an inorganic layered compound and a polymer.

2. A display substrate according to claim 1, wherein a value of retardation (Re) of the display substrate in a wavelength of 632.8 nm is one of 250 to 450 nm and 500 to 650 nm.

3. A display substrate according to claim 2, wherein the plastic film contains a different types of polymers who share the same sign of intrinsic birefringence value while showing different wavelength dispersions.

4. A display substrate according to claim 1, wherein a value of retardation (Re) of the display substrate in a wavelength of 632.8 nm is 15 nm or less.

5. A display substrate according to claim 1, wherein the plastic film is a phase difference plate which satisfies the relation Re(450)<Re(550)<Re(650),
where Re(450), Re(550), and Re(650) are retardation values in wavelengths 450 nm, 550 nm, and 650 nm, respectively.

6. A display substrate according to claim 5, wherein a value of retardation (Re)/wavelength (λ) of the display substrate in wavelengths of 450 nm, 550 nm, and 650 nm of the plastic film is 0.2 to 0.3.

7. A display substrate according to claim 1, wherein the plastic film contains a first material whose intrinsic birefringence value is positive and a second material whose intrinsic birefringence value is negative.

8. A display substrate according to claim 7, wherein the first and the second materials are polymers.

9. A display substrate according to claim 1, wherein the inorganic layered compound is a synthetic mica.

10. A display substrate according to claim 1, wherein at least one of a hard coating layer and an adhesion layer is provided on the gas barrier layer.

11. A display substrate according to claim 10, wherein at least one of the hard coating layer and the adhesion layer has a transparent conductive layer thereon.

12. A display substrate according to claim 11, wherein a color filter is disposed in between the transparent conductive layer and at least one of the hard coating layer and the adhesion layer.

13. A display substrate according to claim 1, wherein an aspect ratio of the inorganic layered compound is 20 or more.

14. A display substrate according to claim 1, wherein an aspect ratio of the inorganic layered compound is 100 or more.

15. A display substrate according to claim 1, wherein the polymer is water-soluble polymer.

16. A display substrate according to claim 1, wherein the polymer includes polyvinyl alcohol which contains vinyl alcohol by 70% or more as a monomer unit and at least one type of compound selected from modifications thereof.

17. A display substrate according to claim 1, wherein the polymer includes at least one type of compound selected from carboxyl-denatured polyvinyl alcohol, silanol-denatured polyvinyl alcohol, and epoxy-denatured polyvinyl alcohol.

18. A display substrate according to claim 1, wherein the polymer contains gelatin.

19. A display substrate according to claim 1, wherein an oxygen transmission rate (40° C. temperature, 90% humidity) of the gas barrier layer is 0.5 ml/m²·atm·day or less.

20. A display substrate according to claim 2, wherein the display substrate is used for an STN (supertwisted nematic) liquid crystal display.
